(19) United States
(12) Patent Application Publication
(10) Pub. No.: US 2021/0213726 A1
(43) Pub. Date: Jul. 15, 2021

(54) TABLET PRINTING APPARATUS AND TABLET PRINTING METHOD

(71) Applicant: SHIBAURA MECHATRONICS CORPORATION, Yokohama-shi (JP)

(72) Inventors: Junpei TANAKA, Yokohama-shi (JP); Junsuke KOMITO, Yokohama-shi (JP); Noritsugu TANIO, Yokohama-shi (JP); Yasutsugu TSURUOKA, Yokohama-shi (JP); Azusa HIRANO, Yokohama-shi (JP)

(21) Appl. No.: 17/214,155

(22) Filed: Mar. 26, 2021

Related U.S. Application Data
(63) Continuation of application No. PCT/JP2019/034674, filed on Sep. 3, 2019.

(30) Foreign Application Priority Data
Sep. 27, 2018 (JP) 2018-181817

(51) Int. Cl. B41F 17/36; B41J 3/407; B41F 33/00; B41F 33/16

(52) U.S. Cl. CPC B41F 17/36; B41F 33/16; B41F 33/0036; B41J 3/4073

(57) ABSTRACT

A tablet printing apparatus 1 according to embodiments includes an imaging device 23 that images a side surface of a tablet T on which a split line is formed on one surface, a carrying device 21 that carries the tablet T, a printing head device 24 that prints information on the tablet T carried by the carrying device 21, and a controlling device 50 that specifies an angle of the split line based on an image obtained by the imaging device 23, creates a printing data for printing the information in accordance with the split line using the specified angle, and controls the printing head device 24 using the created printing data.

### CROSS-REFERENCE TO RELATED APPLICATION

This application is a Continuation of PCT Application No. PCT/JP2019/034674, filed on Sep. 3, 2019, and claims priority to Japanese Patent Application No. 2018-181817, filed on Sep. 27, 2018, the entire contents of both of which are incorporated herein by reference.

### TECHNICAL FIELD

Embodiments of the present disclosure relate to a tablet printing apparatus and a tablet printing method.

### BACKGROUND

To print identification information (an example of information) such as letters and marks on tablets, a technology to perform printing using an inkjet-scheme printing head is known. The tablet printing apparatus using this technology carries tablets by a carrying device such as conveyer, ejects ink (for example, edible ink) toward tablets passing below the printing head from a nozzle of the inkjet-scheme printing head arranged above the carrying device, and prints the identification information on tablets.

For a tablet which has a split line (a linear recess portion) formed on one side, when a surface which has the split line is referred to as an upper surface and a surface which does not have the split line is referred to as a bottom surface, the tablets are carried with the upper surface and the bottom surface in random. In detail, regarding the surface of the tablet contacting with a carrying surface of the carrying device which carries the tablets such as conveyer, there are a case in which the surface is the upper surface on which the split line is formed and a case in which the surface is the bottom surface on which the split line is not formed. When performing printing to the tablets carried with the upper surface and the bottom surface in random, for example, when printing the identification information on the surface on which the split line is not formed, the identification information may be printed to align (for example, in parallel in the direction to which the split line extends) with the split line formed in the opposite surface.

However, if the tablet is carried with the surface on which the split line is not formed facing upward, the split line cannot be detected from an image which is imaged by a camera from above the tablet (that is, from the direction opposite the carrying surface of the carrying apparatus), and the identification information cannot be printed along the split line on the surface on which the split line is not formed. Therefore, it is required to image the tablet which is carried with the surface on which the split line is not formed facing upward from below by the camera to detect the split line from the image. However, since the conveyer supports the tablet from below, to image the tablet which is carried with the surface on which the split line is not formed facing upward from below by the camera, dedicated apparatuses and components are required, making the tablet printing apparatus complicated.

### SUMMARY

### Problems to be Solved

To solve the problems by the present disclosure, the tablet printing apparatus and the tablet printing method that can print information on the surface on which the split line is not formed in accordance with the split line in the case in which the tablet having the split line formed on one surface is carried with the upper surface and the bottom surface in random, and that can simplify the apparatus are provided.

### Means to Solve the Problem

A tablet printing apparatus according to embodiments of the present disclosure includes:

an imaging device that images a side surface of a tablet on which a split line is formed on one surface;

a carrying unit that carries the tablet;

a printing unit that prints information on the tablet carried by the carrying unit; and

a controlling unit that specifies an angle of the split line based on an image obtained by the imaging device, creates a printing data for printing the information in accordance with the split line using the specified angle, and controls the printing unit using the created printing data.

A tablet printing method according to embodiments of the present disclosure includes:

an imaging process of imaging a side surface of a tablet on which a split line is formed on one surface;

a creation process of specifying an angle of the split line based on an image obtained in the imaging process, and creating a printing data for printing the information in accordance with the split line using the specified angle; and

a printing process of printing the information on the carried tablet in accordance with the split line using the created printing data.

### Effect of Invention

According to the present disclosure, information can be printed on the surface on which the split line is not formed in accordance with the split line in the case in which the tablet having the split line formed on one surface is carried with the upper surface and the bottom surface in random, and furthermore, the apparatus can be simplified.

### DESCRIPTION OF THE DRAWINGS

FIG. 1 is a diagram illustrating a tablet printing apparatus according to an embodiment.

FIG. 2 is a plan view illustrating a first printing device according to an embodiment.

FIG. 3 is a diagram illustrating a first imaging device according to an embodiment.

FIG. 4 is a conceptual diagram illustrating an example of an image obtained by imaging a tablet which is carried with a surface on which the split line is not formed facing upward by the first imaging device according to an embodiment.

FIG. 5 is a conceptual diagram illustrating an example of an image obtained by imaging a tablet which is carried with a surface on which the split line is formed facing upward by the first imaging device according to an embodiment.

FIG. 6 is a conceptual diagram illustrating an example of an image obtained by imaging a tablet which is carried with a surface on which the split line is not formed facing upward and with a chipping on the surface on which the split line is not formed facing upward by the first imaging device according to an embodiment.

FIG. 7 is a diagram to describe detecting a split line from an imaged image of tablet in a first shape (a shape in which the upper surface and bottom surface are plane) according to an embodiment.

FIG. 8 is a graph illustrating a shading distribution of a predetermined measurement range in the imaged image of the tablet in the first shape according to an embodiment.

FIG. 9 is a graph illustrating a shading distribution of a predetermined measurement range in the imaged image of the tablet in the first shape according to an embodiment.

FIG. 10 is a graph illustrating a shading distribution of a predetermined measurement range in the imaged image of the tablet in the first shape according to an embodiment.

FIG. 11 is a graph illustrating a shading distribution of a predetermined measurement range in the imaged image of the tablet in the first shape according to an embodiment.

FIG. 12 is a graph illustrating a shading distribution of a predetermined measurement range in the imaged image of the tablet in a second shape (a shape in which the upper surface and bottom surface are curved surfaces) according to an embodiment.

FIG. 13 is a graph illustrating a shading distribution of a predetermined measurement range in the imaged image of the tablet in the second shape according to an embodiment.

FIG. 14 is a graph illustrating a shading distribution of a predetermined measurement range in the imaged image of the tablet in the second shape according to an embodiment.

FIG. 15 is a graph illustrating a shading distribution of a predetermined measurement range in the imaged image of the tablet in the second shape according to an embodiment.

FIG. 16 is a conceptual diagram illustrating an example of an image obtained by imaging a tablet which is carried with a surface on which the split line is formed facing upward by the first imaging device according to an embodiment.

FIG. 17 is a conceptual diagram illustrating an example of an image obtained by imaging a tablet which is carried with a surface on which the split line is formed facing upward by the first imaging device according to an embodiment.

### DESCRIPTION OF PREFERRED EMBODIMENT

### Embodiment

One embodiment is described by referring to figures.

(Basic Structure)

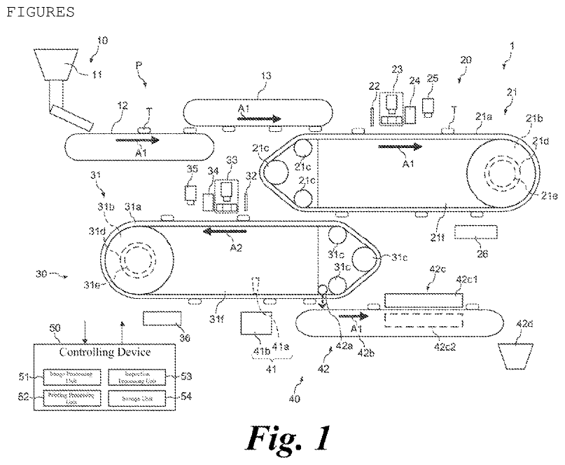

As illustrated in FIG. 1, a tablet printing apparatus 1 according to an embodiment includes a supplying device 10, a first printing device 20, a second printing device 30, a collection device 40, and a controlling device (a controlling unit) 50.

Note that the first printing device 20 and the second printing device 30 basically have the same structures. The supplying device 10, the first printing device 20, the second printing device 30, and the collection device 40, that are the components of the tablet printing apparatus, are arranged in this order to form a carrying path P, and a series of processes of supply, printing, and collection of the tablets T is performed along the carrying path P. That is, the carrying path P is a path on which the tablets T are carried in the tablet printing apparatus 1, and an upstream of the carrying path P is on the supplying device 10-side and a downstream of the carrying path P is on the collection device 40-side. Furthermore, the tablet T is a tablet which a split line (a linear recess portion) on one side. This tablet T has an upper surface, a bottom surface, and a side surface (outer circumferential surface) which connects the upper surface and the bottom surface.

The supplying device 10 has a hopper 11, an alignment feeder 12, and a delivery feeder 13. This supplying device 10 is configured to supply the tablet T that is a printing target to the first printing device 20 and is positioned at one-end-side of the first printing device 20. The hopper 11 accommodates a large number of tablets T and sequentially supplies the tablets T to the alignment feeder 12. The alignment feeder 12 aligns the supplied tablets T in two lines and carries the tablets T to the delivery feeder 13. The delivery feeder 13 sequentially sucks and holds each tablet T aligned in two lines on the alignment feeder 12 from above, carries the held tablets T to the first printing device 20 in two lines, and delivers the tablets T to the first printing device 20. The supplying device 10 is electrically connected to the controlling device 50, and the driving thereof is controlled by the controlling device 50. As the alignment feeder 12 and the delivery feeder 13, for example, a belt carrying mechanism may be used.

The first printing device 20 includes a carrying device (carrying unit) 21, a detection device 22, a first imaging device (imaging device for printing) 23, a printing head device (printing unit) 24, a second imaging device (imaging device for inspection) 25, and a drying device 26.

The carrying device 21 has a carrying belt 21a, a driving pulley 21b, a plurality of (in example of FIG. 1, three) driven pulleys 21c, a motor 21d, a position detector 21e, and a suction chamber 21f. The carrying belt 21a is an endless belt and is bridged across the driving pulley 21b and each driven pulley 21c. The driving pulley 21b and each driven pulley 21c are rotatably provided to an apparatus main body, and the driving pulley 21b is coupled to the motor 21d. The motor 21d is electrically connected to the controlling device 50, and the driving thereof is controlled by the controlling device 50. The position detector 21e is devices such as an encoder and is attached to the motor 21d. This position detector 21e is electrically connected to the controlling device 50 and transmits a detection signal to the controlling device 50. Based on said detection signal, the controlling device 50 can obtain the information of the carrying belt 21a such as position, speed, and moving amount. In this carrying device 21, the carrying belt 21a is rotated together with each driven pulley 21c by the rotation of the driving pulley 21b by the motor 21d to carry the tablets T on the carrying belt 21a to an arrow A1 direction (carrying direction A1) in FIG. 1.

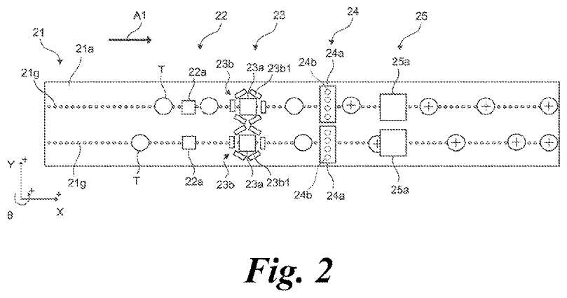

As illustrated in FIG. 2, a plurality of circular suction holes 21g are formed on the surface of the carrying belt 21a. These suction holes 21g are each a through hole to adsorb the tablet T and are arranged in two lines in parallel along the carrying direction A1 to form two carrying paths. Each suction hole 21g is connected to the interior of the suction chamber 21f via suction paths formed in the suction chamber 21f so that the suction holes 21g can obtain suction force by the suction chamber 21f. A suction device such as a pump is connected to the suction chamber 21f via a suction pipe (not illustrated), and the interior of the suction chamber 21f is depressurized by the operation of the suction device. Note that the suction pipe is connected to substantially the center of a side surface of the suction chamber 21f (a surface in parallel with the carrying direction A1). Furthermore, the suction device is electrically connected to the controlling device 50, and the driving thereof is controlled by the controlling device 50.

The detection device 22 has a plurality of (in example of FIG. 2, two) detection units 22a. The detection unit 22a is provided at the downstream side than the position in the carrying belt 21a where the tablet T is supplied by the supplying device 10. The detection unit 22a is arranged one each for the carrying path of the tablet T in the direction which crosses the carrying direction A1 in the horizontal plane (for example, a direction orthogonal to the carrying direction A1) and is provided above the carrying belt 21a. The detection unit 22a detects the position of the tablet T on the carrying belt 21a by the light reception of the laser light, and acts as a trigger sensor for each device positioned at the downstream side. As the detection unit 22a, various laser sensors, such as a reflective laser sensor may be used. Each detection unit 22a is electrically connected to the controlling device 50 and transmits the detection signal to the controlling device 50.

The first imaging device 23 has a plurality of (in example of FIG. 2, two) imaging units 23a and a plurality of (in example of FIG. 2, two) light guide members 23b. Theses light guide members 23b are provided for each imaging unit 23a. Note that since each imaging unit 23a has the same structures and each light guide member 23b has the same structure, the descriptions will not be repeated.

The imaging units 23a are provided at the downstream side in the carrying direction A than the position where the detection device 22 is provided. The imaging units 23a are arranged one each for the carrying path of the tablet T in the direction which crosses the carrying direction A1 in the horizontal plane (for example, a direction orthogonal to the carrying direction A1) and is provided above the carrying belt 21a. This imaging unit 23a performs imaging at a timing when the tablet T reaches right below the imaging unit 23a based on the position information of the tablet T, acquires an image including the upper surface of the tablet T (image for printing), and transmits the acquired image to the controlling device 50. As imaging units 23a, various cameras having an imaging element such as a CCD (Charge Coupled Device) and a CMOS (Complementary Metal Oxide Semiconductor) may be used. Each imaging unit 23a is electrically connected to the controlling device 50, and the driving thereof is controlled by the controlling device 50. Note that lighting for imaging is provided, if necessary.

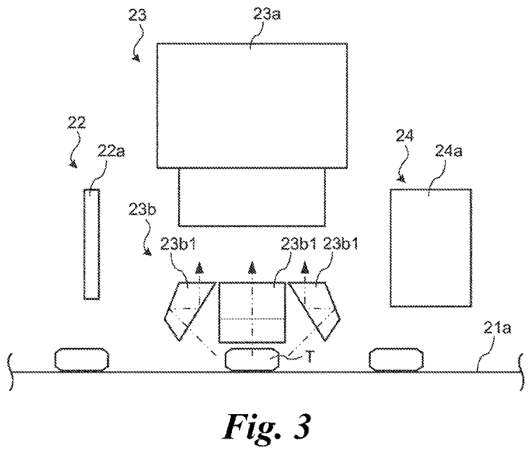

As illustrated in FIGS. 2 and 3, the light guide members 23b is configured by a plurality of prisms 23b1 (in example of FIG. 2, six). These prisms 23b1 is positioned below the imaging unit 23a, is arranged circularly (in a ring-shape) in the horizontal plane two by two in which the two are in parallel and face each other, and is formed to link the image of all side surface (around the outer circumferential surface) of the tablet T that has reached right below the imaging unit 23a to the imaging element of the imaging unit 23a. A center position of an imaging region (imaging range) of the imaging unit 23a and a center position of the ring formed by prisms 23b1 are positioned in the same vertical line. As described above, an imaging timing is a timing when the tablet T has reached right below the imaging unit 23a, that is, the imaging is performed when the position of the tablet T in the carrying direction A1 is positioned in the center position of the imaging region of the imaging unit 23a in the carrying direction A1. Normally, since the position of the tablet T in the direction orthogonal to the carrying direction A1 in the horizontal plane will not be largely displaced, the image of the upper surface of the tablet T will exist in substantially the center of the imaging region of the imaging unit 23a.

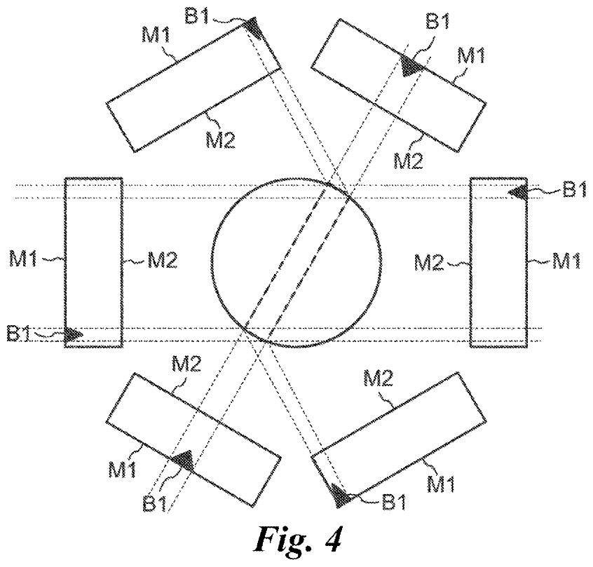

As illustrated in FIGS. 4 to 6, when the imaging is performed by said imaging unit 23a, an image including the upper surface and all side surface of the tablet T is obtained. The upper surface of the tablet T is directly imaged by the imaging unit 23a, and all side surface of the tablet T is imaged by the imaging unit 23a via the light guide member 23b (refer FIG. 3). In the image imaged in such a way, the image of the upper surface of the tablet T is in substantially the center and the images of each side surface of the tablet T by respective prism 23b1 are in the surrounding of the image of the upper surface. The images of each side surface of the tablet T by the prism 23b1 are arranged so as to surround the image of the upper surface of the tablet T. In the images of each side surface of the tablet T, a mark M1 is a surface corresponding to a surface of the tablet T in contact with the carrying belt 21 (hereinafter, referred to as a bottom surface M1), and a mark M2 is a surface corresponding to a surface opposite to the bottom surface M1 (hereinafter, referred to as an upper surface M2). Note that, in the light guide member 23b, the number and arrangement of the prisms 23b1 are adjusted such that the imaging unit 23a can image the image of all side surface (around the outer circumferential surface) of the tablet T.

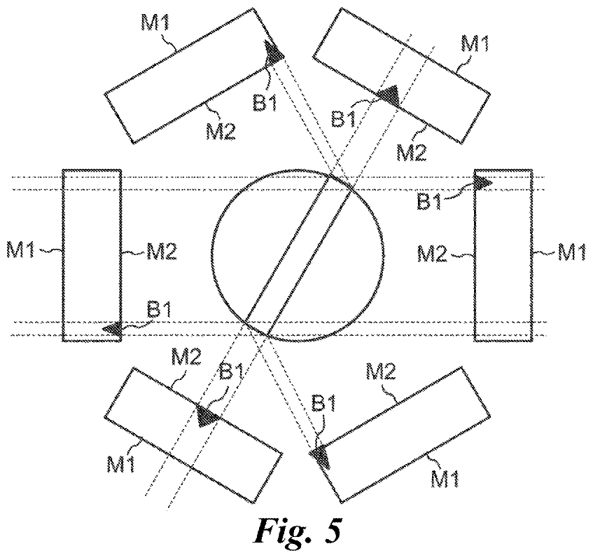

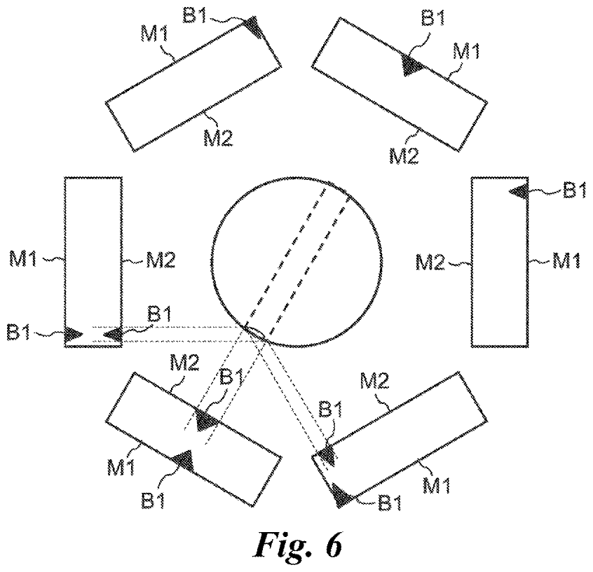

Among the plurality of the tablets T which are carried, tablets having chippings may be included. The “chipping” is a state in which a part of the tablet T is chipped and in which there are recess portion on the tablet T. Such chippings may largely occur at corners of the tablet T. FIGS. 4 to 6 are image examples, and FIG. 4 illustrates an image in which the tablet T which is carried with the surface on which the split line is not formed facing upward is imaged by the imaging unit 23a (no chipping). Furthermore, FIG. 5 illustrates an image in which the tablet T which is carried with the surface on which the split line is formed facing upward is imaged by the imaging unit 23a (without chipping), and FIG. 6 illustrates an image in which the tablet T which is carried with a surface on which the split line is not formed facing upward and with the chipping on the corner of the surface on which the split line is not formed facing upward is imaged by the imaging unit 23a (with chippings).

When there are recess portions, such as chipping or split line, on the tablet T, such recess portions have low reflectance compared to the other portions of the tablet T. As shown in the image in FIG. 4, in each image of the side surfaces of the tablets T by respective prisms 23b1, black triangles (dark portions) B1 are present in the bottom surfaces M1. Note that black triangles in the figures schematically illustrate the dark portions presented in the imaged image, and the dark portions presented in images which were actually obtained are not necessarily triangles. Furthermore, in the image illustrated in FIG. 5, in each image of the side surfaces of the tablets T by respective prisms 23b1, black triangles B1 are present in the upper surfaces M2. In the image illustrated in FIG. 6, in each image of side surfaces of the tablets T by respective prisms 23b1, the black triangles B1 are present on the bottom surface M1 as in FIG. 4, and in three of the images, the black triangles B1 are present on the upper surface M2. Such black triangles B1 are created by the split line or chippings.

As imaged illustrated in aforementioned FIGS. 4 and 6, since the surfaces and positions where the black triangles B1 are present and numbers of the black triangles B1 are different the black triangles B1 which are created by the split line can be recognized, and the surface on which the split line is formed and the angles (direction) of the split line can be specified. For example, if the black triangles B1 are present on two positions facing each other across the center of the tablet T, it can be determined that those black triangles B1 are created by the split line (this will be described later). On the other hand, if the black triangles B1 are not present on two positions facing each other across the center of the tablet T, it can be determined that the black triangles B1 are created by the chippings, not the split line which is a straight line.

Returning to FIGS. 1 and 2, the printing head device 24 includes a plurality of (in example of FIG. 2, two) inkjet-scheme printing heads 24a. The printing heads 24a are provided at the downstream side in the carrying direction A than the position where the first imaging device 23 is provided. The printing heads 24a are arranged one each for the carrying path of the tablet T in the direction which crosses the carrying direction A1 in the horizontal plane (for example, a direction orthogonal to the carrying direction A1) and is provided above the carrying belt 21a. The printing head 24a includes a plurality of nozzles 24b (refer FIG. 2, in which only four nozzles are illustrated) and ejects ink from each nozzle 24b. These printing heads 24a are provided so that the alignment direction of the nozzle 24b crosses with the carrying direction A1 in the horizontal plane (for example, a direction orthogonal to the carrying direction A1). As the printing head 24a, various inkjet-scheme printing heads having a driving element such as piezoelectric element, heating element, or magnetostrictive element may be used. Each printing head 24a is electrically connected to the controlling device 50, and the driving thereof is controlled by the controlling device 50. Note that lighting for imaging is provided, if necessary.

The second imaging device 25 includes a plurality of (in example of FIG. 2, two) imaging unit 25a. The imaging units 25a are provided at the downstream side in the carrying direction A than the position where the printing head device 24 is provided. The imaging units 25a are arranged one each for the carrying path of the tablet T in the direction which crosses the carrying direction A1 in the horizontal plane (for example, a direction orthogonal to the carrying direction A1) and is provided above the carrying belt 21a. This imaging unit 25a performs imaging at a timing when the tablet T reaches right below the imaging unit 25a based on the position information of the tablet T, acquires an image including the upper surface of the tablet T (image for detection), and transmits the acquired image to the controlling device 50. As imaging units 25a, various cameras having an imaging element such as a CCD and a CMOS may be used as the imaging unit 23a. Each imaging unit 25a is electrically connected to the controlling device 50, and the driving thereof is controlled by the controlling device 50. Note that lighting for imaging is provided, if necessary.

The drying device 26 is located at the downstream side in the carrying direction A1 than the position in the carrying belt 21a where the printing head device 24 is provided, and for example, is provided below the carrying device 21. This the drying device commons for two-line carrying path and dries ink applied on the tablet T on the carrying belt 21a. As the drying device 26, various drying units such as a blower to perform drying by gas such as air, a heater to perform drying by radiant heat, or a blower to perform drying by warm air or hot air by using gas and a heater together may be used. The drying device 26 is electrically connected to the controlling device 50, and the driving thereof is controlled by the controlling device 50.

The tablet T which has passed above the drying device 26 is moved along with the movement of the carrying belt 21a and reaches a position near the end of the carrying belt 21a at the driven pulley 21c-side. At this position, the suction effect relative to the tablet T stops working, and the tablet T is released from the state being held by the carrying device and is delivered from the first printing device 20 to the second printing device 30.

The second printing device 30 includes a carrying device 31, a detection device 32, a first imaging device (imaging device for printing) 33, a printing head device (printing unit) 34, a second imaging device (imaging device for inspection) 35, and a drying device 36. The carrying device 31 has a carrying belt 31a, a drive pulley 31b, a plurality of (in example of FIG. 1, three) driven pulleys 31c, a motor 31d, a position detector 31e, and a suction chamber 31f. Note that, since each component configuring the second printing device 30 basically has the same structure as the corresponding components of the aforementioned first printing device 20, the descriptions thereof are omitted. The carrying direction of the second printing device 30 is a direction of an arrow A2 in FIG. 1 (the carrying direction A2).

The collection device 40 includes a defective product collection device 41 and a qualified product collection device 42. This collection device 40 is provided at the downstream side in the carrying direction A2 than the position where the drying device 36 of the second printing device 30 is provided, collects the defective tablet T by the defective product collection device 41 and collects the qualified tablet T by the qualified product collection device 42.

The defective product collection device 41 includes an injection nozzle 41a and a containment device 41b. The injection nozzle 41a provided inside the suction chamber 31f of the second printing device 30, injects gas (for example, air) toward the tablet T carried by the carrying belt 31a (the defective tablet T) to drop the tablet T from the carrying belt 31a. At this time, gas injected from the injection nozzle 41a passes through the suction hole of the carrying belt 31a (similarly to the suction hole 21g indicated in FIG. 2) and hits the tablet T. The injection nozzle 41a is electrically connected to the controlling device 50, and the driving thereof is controlled by the controlling device 50. The containment device 41b receives and contains the tablet T dropped from the carrying belt 31a.

The qualified product collection device 42 includes a gas blowing unit 42a, an ejection feeder (ejection and carrying device) 42b, a drying device 42c, and a containment device 42d. This qualified product collection device 42 is provided at the downstream side in the carrying direction A2 than the position where the defective product collection device 41 is provided.

The gas blowing unit 42a is provided inside the carrying device 31 of the second printing device 30 at the end of the carrying device 31, that is, provided at the end of the carrying belt 31a at the driven pulley 31c-side. For example, The gas blowing unit 42a constantly blows gas (for example, air) toward the carrying belt 31a to drop the tablet T from the carrying belt 31a during the printing process. At this time, gas blown from the gas blowing unit 42a passes through the suction hole of the carrying belt 31a (similarly to the suction hole 21g indicated in FIG. 2) and hits the tablet T. As the gas blowing unit 42a, for example, an air blow having a slit-shape opening extending in the direction which crosses the carrying direction A2 in the horizontal plane (for example, a direction orthogonal to the carrying direction A2) may be used. The gas blowing unit 42a is electrically connected to the controlling device 50, and the driving thereof is controlled by the controlling device 50.

Here, the tablet T which has passed the defective product collection device 41 is moved along with the movement of the carrying belt 31a and reaches a position near the end of the carrying belt 31 at the driven pulley 31c-side. At this position, although the suction effect relative to the tablet T stops working, gas is blown toward the tablet T from above by the gas blowing unit 42a, and the tablet T drops from the carrying belt 31a. Therefore, by providing the gas blowing unit 42a, the tablet T can be surely dropped from the carrying belt 31a so as to be supplied to the ejection feeder 42b.

The ejection feeder 42b receives the tablet T dropped from the lower surface of the carrying belt 31a and carries the received tablet T to the containment device 42d. Note that, as the ejection feeder 42b, for example, a belt carrying mechanism can be used. The belt of this ejection feeder 42b is an endless belt having gas permeability. As the belt having gas permeability, a belt which is formed of various materials and which has a plurality of through holes, such as a reticular belt and a belt having a plurality of circular holes may be used. The ejection feeder 42b is electrically connected to the controlling device 50, and the driving thereof is controlled by the controlling device 50.

The drying device 42c includes an upper drying unit 42c1 and a lower drying unit 42c2. This drying device 42c dries the tablet T carried by the ejection feeder 42b by the upper drying unit 42c1 and the lower drying unit 42c2 using dry gas (for example, dry air). This drying device 42c is electrically connected to the controlling device 50, and the driving thereof is controlled by the controlling device 50. As the drying device 42c, other than a device to perform drying by dry gas, various drying units such as a blower to perform drying by gas such as air, a heater to perform drying by radiant heat, or a blower to perform drying by warm air or hot air by using gas and a heater together may be used.

The upper drying unit 42c1 is provided above the ejection feeder 42b and blows dry gas downward from above the ejection feeder 42b. A housing of the upper drying unit 42c1 is formed in a box-shape with a bottom surface opened and is provided to cover the carrying surface of the upper surface of the carrying belt of the ejection feeder 42b so that the bottom surface thereof faces downward. In the housing of the upper drying unit 42c1, a nozzle (not illustrated) which blows dry gas is arranged, and the dry gas is blown from the nozzle toward the upper surface of the carrying belt of the ejection feeder 42b. This dry gas flows toward the upstream end and the downstream end of the ejection feeder 42b along the carrying path of the ejection feeder 42b. By this, the space in the housing of the upper drying unit 42c1 is constantly maintained in dry atmosphere.

The lower drying unit 42c2 is provided inside the ejection feeder 42b and blows dry gas upward from inside the ejection feeder 42b. A housing of the lower drying unit 42c2 is formed in a box-shape with an upper surface opened and is provided inside the ejection feeder 42b so that the upper surface thereof faces upward. In the housing of the lower drying unit 42c2, a nozzle (not illustrated) which blows dry gas is arranged, and the dry gas is blown from the nozzle toward the lower surface of the carrying belt of the ejection feeder 42b. This dry gas flows toward the upstream end and the downstream end of the ejection feeder 42b along the carrying path of the ejection feeder 42b. By this, the space in the housing of the lower drying unit 42c2 is constantly maintained in dry atmosphere.

The containment device 42d is positioned at the downstream end of the ejection feeder 42b, that is, at the end of the ejection feeder 42b opposite to the second carrying device 31-side and is provided outside the housing of the tablet printing apparatus 1. This containment device 42d receives and contains the tablet T which the ink thereon was dried by the drying device 42c from the ejection feeder 42b.

The controlling device 50 includes an image processing unit 51, a printing processing unit 52, an inspection processing unit 53, and a storage unit 54. The image processing unit 51 processes images (described later in detail). The printing processing unit 52 performs processing related to printing. The inspection processing unit 52 performs processing related to inspection. The storage unit 54 stores various information such as processing information and various programs. Such a controlling device 50 controls the supplying device 10, the first printing device 20, the second printing device 30, and the collection device 40, and receives position information of tablet T transmitted from respective detection devices 22 and 32 of the first printing device and the second printing device 30, and images transmitted from respective imaging devices 23, 25, 33, 35 of the first printing device 20 and the second printing device 30, etc.

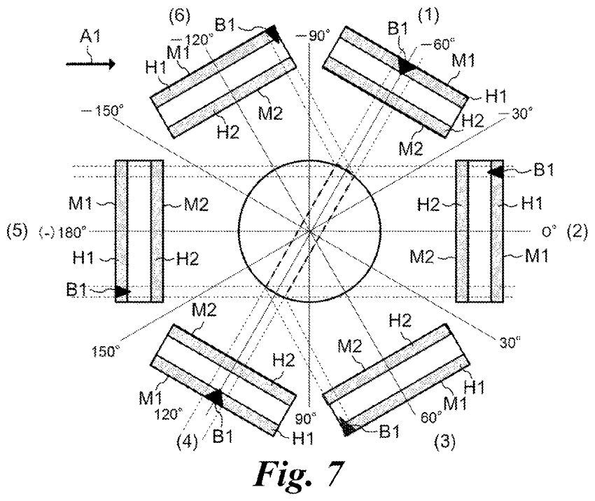

As illustrated in FIG. 7, the image processing unit 51 recognizes respective images (1) to (6) of the side surfaces of the tablet T by the six prisms 23b1 and specifies the surface on which the split line is formed and an angle (direction) of the split line. The printing processing unit 52 creates a printing data related to printing based on information related to the surface on which the split line is formed and the angle (direction) of the split line. Note that the image illustrated in FIG. 7 is the same as the image illustrated in FIG. 4, and as described above, illustrates the image in which the tablet T which is carried with the surface on which the split line is not formed facing upward is imaged by the imaging device 23a (no chipping).

Here, the image illustrated in FIG. 7 is obtained when the split line is positioned at −60 degrees (+120 degrees) from the center of the tablet T. Note that, in FIG. 7, the downstream side in parallel with the carrying direction A1 is 0 degree, and anticlockwise direction is described as − angle and clockwise direction is described as +angle. In the image (1) of the side surface of the tablet T, 180 degrees from −150 degrees to +30 degrees of the tablet T are the field of view, in the image (2) of the side surface of the tablet T, 180 degrees from −90 degrees to +90 degrees of the tablet T are the field of view, and in the other images (3) to (6) of the side surface of the tablet T, 180 degrees are the field of view. Regarding the arrangement of the six prisms 23b1, since the field of view of the prisms 23b1 overlaps as described above, the black triangles B1 (peak: a portion darker than other portion) that are the black portion in the images (1) to (6) of the side surfaces of the tablet T appears in part. When these black triangles B1 appear at (substantially) 180 degrees opposite to each other in two opposite images (image (1) and image (4) in FIG. 7), it can be determined that theses black triangles B1 are produced by the split line (not by chipping).

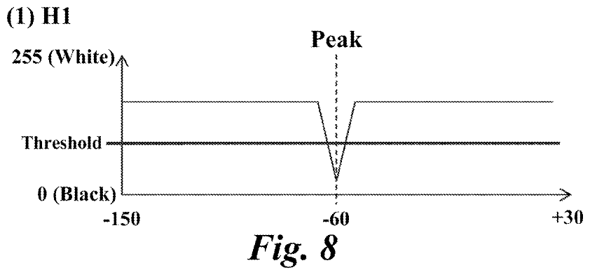

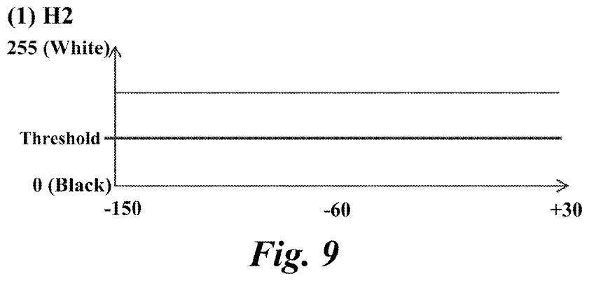

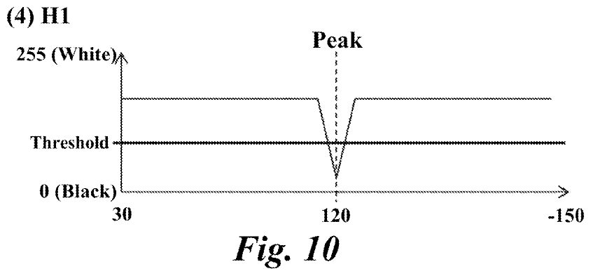

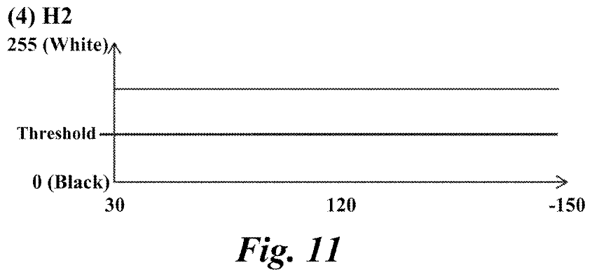

FIGS. 8 to 11 are graphs illustrating shading distributions obtained by performing an image processing by the image processing unit 51 on the image imaged by the imaging unit 23a. The imaging unit 23a is, for example, a black and white camera, and a portion expressed brightly in the image is indicated by white and a portion expressed dark in the image is indicated by black. As illustrated in FIG. 8, in the image (1) of the side surface of the tablet T, the shading distribution in the predetermined measurement range (rectangular region) H1 at the bottom surface M1-side has the peak thereof at −60 degrees. Furthermore, as illustrated in FIG. 9, the shading distribution in the predetermined measurement range (rectangular region) H2 at the upper surface M2-side is not changed from flat. In addition, as illustrated in FIG. 10, in the image (4) of the side surface of the tablet T, the shading distribution in the predetermined measurement range H1 at the bottom surface M1-side has the peak thereof at +120 degrees. Moreover, as illustrated in FIG. 11, the shading distribution in the predetermined measurement range H2 at the upper surface M2-side is not changed from flat.

As illustrated in FIGS. 8 to 11, a threshold (predetermined shading) is set. The peak exceeds the threshold at the position of −60 degrees which is the position corresponding to the black triangle B1 as the image (1) illustrated in FIG. 8. In addition, similar peak appears at the position of +120 degrees which is the position corresponding to the image (4) in FIG. 10 and which is the position opposite the above peak. In this case, it is determined that the black triangles B1 corresponding to the peaks are due to the split line (linear recess portion). On the other hand, if the similar peak does not appear at the opposite position, it is determined that the black triangle B1 corresponding to the peak is produced by chipping, and not by the split line. Note that, the shading distribution is used, or if both ends of the tablet T seem dark, gradation difference from the adjacent pixel is used. When the split line is recognized by this, the surface on which the split line is formed and the angle of the split line are specified. In the specification of the split line, it is specified that the surface on which the split line is formed is the bottom surface based on the bottom surface M1 of the image in which the black triangle B1 corresponding to the peak exceeding the threshold is present. Furthermore, in the specification of the angle of the split line, the angle is specified from the position of the peak exceeding the threshold. In FIGS. 8 and 10, the angle of the split line is −60 degrees (+120 degrees).

In this way, in respective images (1) to (6) of the side surfaces of the tablet T by the six prisms 23b1, the image processing unit 51 recognizes the black triangles B1 produced by the split line and the black triangles B1 produced by chippings. Then, the image processing unit 51 specifies the surface on which the split line is formed based in the surface (M1 or M2) of the image on which the black triangles B1 produced by the split line is present. Furthermore, the image processing unit 51 specifies the angle of the split line based on the position of the black triangle B1 in which the shading produced by the split line exceeds the threshold (darker than the threshold).

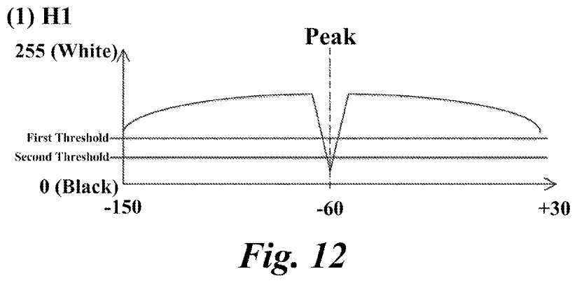

Note that, in two images (1) and (4) of the side surface of the tablet T by the aforementioned prisms 23b1, a case in which the upper and bottom surfaces of the tablet T is plane (first shape) is indicated. Here, shading distribution of a case in which the upper and bottom surfaces of the tablet T is curved (second shape) is described by referring to FIGS. 12 to 15.

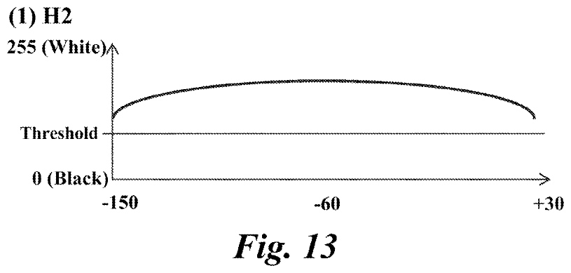

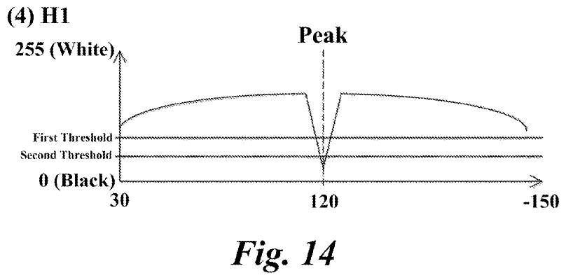

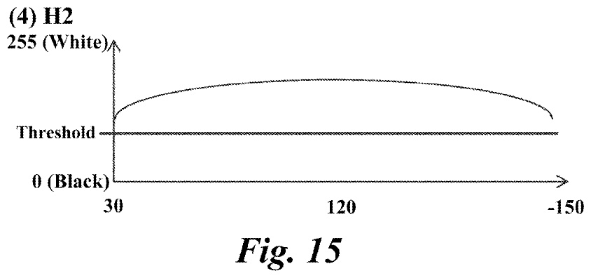

As illustrated in FIG. 12, in the image (1) of the side surface of the tablet T, the shading distribution in the predetermined measurement range H1 at the bottom surface M1-side has the peak at −60 degrees. Furthermore, as illustrated in FIG. 13, the shading distribution in the predetermined measurement range H2 at the upper surface M2-side is curved and changed. In addition, as illustrated in FIG. 14, in the image (4) of the side surface of the tablet T, the shading distribution in the predetermined measurement range H1 at the bottom surface M1-side has the peak at +120 degrees. Moreover, as illustrated in FIG. 15, the shading distribution in the predetermined measurement range H2 at the upper surface M2-side is curved and changed.

Note that, in the shading distribution, when the upper and bottom surface of the tablet T is curved, both ends of the tablet T in the graph appears in black. To distinguish this portion from the peak by the split line and chipping, as illustrated in FIGS. 12 and 14, it is preferable to provide a two-stage threshold. As the role for these thresholds, the first threshold is a threshold for detecting a portion that is black in some level (representing a portion which is not a shadow of the end but chipped even though it is not clear if it is the split line). Furthermore, the second threshold is a threshold for detecting a portion that is more black than the first threshold (split line). By providing two-stage threshold, “shadow of the end” and “chipping” of the tablet can be distinguished from each other. Furthermore, by providing two-stage threshold, the split line or the chipping can be determined without checking if the black portions are facing (corresponding to) each other.

(Printing Process)

Next, the printing process and the detection process performed tablet printing apparatus 1 will be described. In the following printing process, a double-side printing to print the identification information which aligns with the split line (for example, in parallel with the extending direction of the split line) on both surfaces of the tablet T on which the split line is formed on one side will be described.

Firstly, various information such as printing data required for printing are stored in the storage unit 54 of the controlling device 50. Then, when a number of the tablets T that are the printing target is input to the hopper 11 of the supplying device 10, the tablets T are sequentially supplied to the alignment feeder 12 from the hopper 11 and is aligned and moved in two lines by the alignment feeder 12. These tablets T aligned in two lines are sequentially supplied to the carrying belt 21a of the first printing device 20 by the delivery feeder 13. The carrying belt 21a is rotated in the carrying direction A1 by the rotation of the driving pulley 21b and the driven pulleys 21c by the motor 21d. Therefore, the tablets T supplied on the carrying belt 21a are aligned and carried in two lines in a predetermined speed. Note that the carrying belt 31a is rotated in the carrying direction A2 also by the rotation of the driving pulley 21b and the driven pulleys 21c by the motor 21d.

In the first printing device 20, the tablet T is sucked and held on the carrying belt 21a, and the tablet T on the carrying belt 21a is detected by the detection device 22. By this, the position information (position in the carrying direction A1) of the tablet T is obtained and is input to the controlling device 50. This position information of the tablet T is stored in the storage unit 54 and is used in the post-processing. Next, the tablet T on the carrying belt 21a is imaged by the first imaging device 23 based on the position information of the tablet T, and the imaged image is transmitted to the controlling device 50.

In the image processing unit 51 of the controlling device 50, each image transmitted by the first imaging device 23 is determined if the black triangles B1 on the images of the side surfaces of the tablet T is by the split line, and the surface on which the split line is formed and the angle of the split line are detected based on the black triangles by the split line. That is, the image processing unit 51 detects where on which image among the images of the side surfaces of the tablet T did the black portion appear, and checks if the black portion has appeared on the portion facing (corresponding) thereto (portion that is 180 degrees opposite). By this, on which angle does the “split line”, not the “chipping”, is formed at the bottom surface side-M1 (that is, the surface contacting the carrying belt 21a or 31a) is found, and based on this, the printing data to perform printing by the printing head device 24 at the downstream side can be created. The printing data, based on the information on a split line formation surface and a split line angle (the surface on which the split line is formed and the angel of the split line) obtained by this, and a misposition information of the tablet T obtained from the image of the upper surface of the tablet T (for example, misposition of the tablet T in the X-direction, Y-direction, and θ-direction in FIG. 2) imaged by the imaging unit 23a, is created by the printing processing unit 52 and is stored in the storage unit 54. Based on this printing data, the printing condition (such as ejection position and ejection speed of ink) for the tablet T is set by the printing processing unit 52 and is stored in the storage unit 54. Note that the printing data is a printing data to print the identification information (one example of the information) in accordance with the split line (for example, in a direction in parallel with the direction of the split line).

Next, the printing is performed on the tablets T on the carrying belt 21a by the printing head device 24 based on the printing data and printing condition at the timing based on the position information of the tablet T, that is, at the timing when the tablet T has reached below the printing head unit 24. In the printing head device 24 and the printing heads 24a, ink is ejected as appropriate from the nozzles 24b, and the identification information such as letters (for example, alphabets, Katakanas, numbers) and marks (for example, sings and figures) are printed on the upper surface of the tablet T to align with the split line (for example, in parallel with the extension direction of the split line).

The tablet T on which the identification information has been formed are imaged by the second imaging device 25 at the timing based on the position information of the tablet T, and the imaged image is transmitted to the controlling device 50. Based on the images transmitted from the second imaging device 25, a printing position information indicating the printing position of the printing pattern for the tablet T is created by the image processing unit 51 and is stored in the storage unit 54. Based on the printing position information, the printing quality for the tablet T is determined by the inspection processing unit 53 and a printing quality result information indicating the printing quality for the tablet T is stored in the storage unit 54. For example, if the printing pattern was printed on the predetermined position on the tablet T or not is determined.

The tablet T after the detection is carried along with the movement of the carrying belt 21a and passes above the drying device 26 during the drying operation. At this time, ink that has reached (hit) the tablet T is dried by the drying device 26 when the tablet T passes above the drying device 26, and the tablet T which the ink thereon was dried is carried along with the movement of the carrying belt 21a and would be positioned near the end of the carrying belt 21a at the driven pulleys 21c-side. At this position, the suction effect relative to the tablet T stops working, and the tablet T is released from the state being held by the bottom surface of the carrying belt 21a and is delivered from the first printing device 20 to the second printing device 30.

Also in the second printing device 30, the tablet T is sucked and held on the carrying belt 31a, and the printing process and the detection process are performed similarly to above description. The tablet T after the detection is carried along with the movement of the carrying belt 31a and passes above the drying device 36 during the drying operation. Then, the tablet T which the ink thereon was dried reaches the defective product collection device 41. At this position, the defective tablet T drops from the bottom surface of the carrying belt 31a by gas blown out from the gas blowing unit 41a and is collected by the containment device 41b. On the other hand, the qualified tablet T passes through the defective product collection device 41 and reaches the qualified product collection device 42. At this position, the suction effect relative to the tablet T stops working, and the tablet T drops from the bottom surface of the carrying belt 31a by gas blown out from the gas blowing unit 42a and is delivered to the ejection feeder 42b.

The qualified tablet T is carried by the ejection feeder 42b and passes between the upper drying unit 42c1 and lower drying unit 42c2 of the drying device 42c during the drying operation. Since dried gas is blown to the tablet T on the belt of the ejection feeder 42b from the upper drying unit 42c1 and the lower drying unit 42c2, the tablet T is dried and the dried condition thereof is maintained. Furthermore, even when the tablet T contained moisture due to the humidity in the carrying path at the upstream side than the ejection feeder 42b, the tablet T can be surely dried by the upper drying unit 42c1 and the lower drying unit 42c2 while being carried by the ejection feeder 42b. At this time, since the carrying speed of the ejection feeder 42b is very slow when compared with the carrying speed at the time of printing, the tablet T inside the divided space stays in the space with the dried gas for 10 to 20 minutes, so that the tablet T is surely dried. Note that these can be also applied to the ink printed on the tablet T, and the ink can be surely dried even when the drying of the ink was insufficient, while maintaining the dried condition of the ink. The tablet T dried by the drying device 42c is carried to the above of the containment device 42d by the ejection feeder 42b, drops from the downstream end of the ejection feeder 42b, and is collected by the containment device 42d.

According to such printing processing procedure, in the first printing device 20, all side surfaces of the tablet T on which a split line is formed on one surface are imaged by the imaging unit 23a of the first imaging device 23, the surface on which the split line is formed and the angle of the split line are specified by the image processing unit 51 based on the image obtained in the imaging unit 23a, and the printing data for printing the information to align with the split line is created. Then, the printing head device 24 is controlled by the controlling device 50 using the created printing data. By imaging all side surfaces of the tablet T by the imaging unit 23a, the split line which is formed on one of the upper surface and the bottom surface can be recognized by said image. By this, even when the tablet T is carried with the surface on which the split line is not formed is facing upward, the identification information aligning with the split line can be formed on the surface on which the split line is not formed. Furthermore, by only imaging all side surfaces of the tablet T by the imaging unit 23a, the split line which is formed on one of the upper surface and the bottom surface can be recognized by said image. By this, for example, the simplification of the configuration of the apparatus can be realized in comparison with the case in which the split line is recognized by using two dedicated cameras which respectively image both the upper surface and the bottom surface of the carried tablet T. Note that the printing data is created and the printing head device 34 is controlled also in the second printing device 30.

Here, for example, when the side surface of the tablet T is not imaged by the imaging unit 23a, two dedicated cameras which respectively image both the upper surface and the bottom surface of the carried tablet T are required. However, since the bottom side of the carried tablet T is supported by the carrying belt 21a, various devices and components are newly required to image the bottom surface of the tablet T by the dedicated camera from below the tablet T which is carried with the surface on which the split line is not formed facing upward. For example, the tablet T is sucked and held from above and is carried, and the held tablet T is imaged by the camera from below, and this requires a dedicated conveyor which sucks and carries the tablet T, a dedicated camera, and various fittings, such that the tablet printing apparatus become complicated.

In addition, according to the printing processing procedure, if there is chipping on the tablet T or not can be determined at the upstream side than the printing head device 24 in the carrying path P. By this, when there is chipping on the tablet T, the printing and the detection process on said tablet T which has chipping may not be performed, so that the production efficiency can be improved.

As described above, according to the embodiment of the present disclosure, the imaging unit 23a that images all around the side surface of the tablet T on which the split line is formed on one surface, and the controlling unit 50 that specifies the surface on which the split line is formed and the angle of the split line based on the image obtained by the imaging unit 23a, creates the printing data for printing the information aligned with the split line, and controls the printing head device 24 using the created printing data are provided. By this, only by imaging all around the side surface of the tablet T on which the split line is formed on one surface by the imaging unit 23a, the split line which is formed on one of the upper surface and the bottom surface can be recognized by said image, and the information which is aligned with the split line can be printed on the surface on which the split line is not formed in the case in which the tablet having the split line formed on one surface is carried with the upper surface and the bottom surface in random, and furthermore, the simplification of the apparatus can be achieved.

### Other Embodiments

In the above description, although the light guide member 23b is configured by six prisms 23b1, it is not limited thereto, and the number of prisms 23b1 may be, for example, three, four, or five to eight, and may be an even number or an odd number. Furthermore, although prisms 23b1 are arranged to form a hexagonal ring, it is not limited thereto, and the prisms 23b1 may be formed, for example, to form a polygonal ring, such as triangle, quadrilateral, or pentagon, hexagon, heptagon, or octagon.

In addition, one of the prisms 23b1 may be used as the light guide member 23b, and this one prisms 23b1 may form ring-shape such as circle and ellipse. Note that the prisms 23b1 may be integrated.

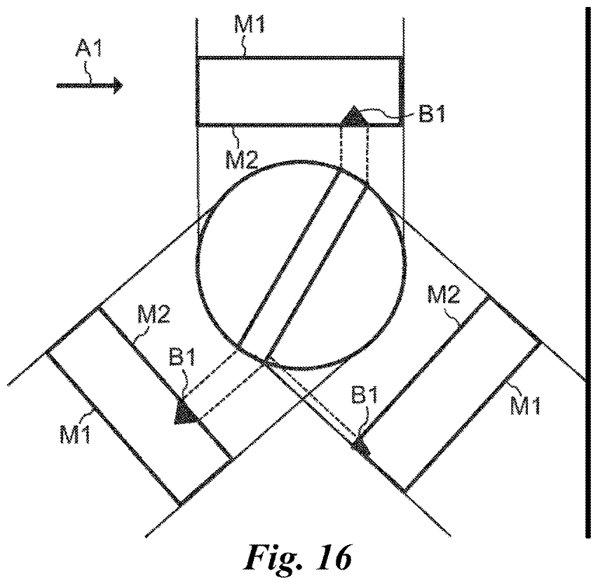

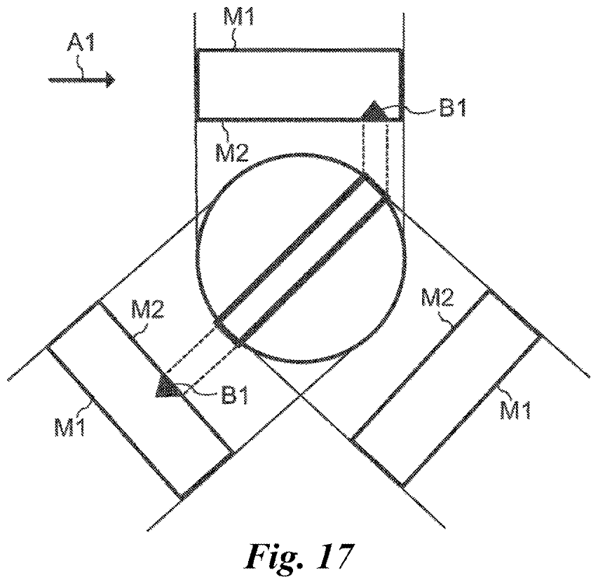

Here, when prisms 23b1 may be in even numbers, the black triangles by the split line each appear at the surface on the same side in the respective images by two prisms 23b1 facing each other in parallel (bottom surface M1 or upper surface M2: refer FIG. 7). On the other hand, as illustrated in FIGS. 16 and 17, when there are three prisms 23b1, that is, the prisms 23b1 are in odd number, images of the side of the side surfaces of the tablet T by the prisms 23b1 are no facing each other in parallel, and the black triangles B1 by the split line corresponding to two positions of the tablet T facing each other appear in respective images by two prisms 23b1. Therefore, it can be determined whether the black triangle B1 is by the split line or by chipping or dirt. Note that, when there is the split line on the tablet T, two or more black triangles always appear because the black triangles B1 each appear at the surface on the same side in the respective images by two prisms 23b1.

In the figure illustrated in FIG. 16, the black triangles B1 (black portions) appear on each of the images by three prisms 23b1. When the black triangles B1 appear at the corresponding position in the region assigned for each prism 23b1 (for example, −60 degrees and +120 degrees), it is found that the black triangles B1 are present in accordance with the position on the tablet T facing across the center of the tablet T, and the black triangles formed by the split line can be specified. When referring FIG. 16 by the front view, the range of the field of view of the prism on the top is from 0 degree to −180 degrees, the range of the field of view of the prism on the lower right is from −45 degrees to 135 degrees, the range of the field of view of the prism on the lower left is from +45 degrees to +225 degrees.

In the figure illustrated in FIG. 17, since the image by one of the prisms 23b1 among three prisms 23b1 and the split line is in parallel, the end of the split line does not appear on the image by the prism on the lower right when referring FIG. 17 by the front view, and the black triangles B1 appear on the respective image by other two prisms 23b1. That is, when the numbers of the prisms 23b1 is in odd number (for example, three), two or more black triangles B1 always appear if there is the split line. Although it seems different from the case in which even number of the prisms 23b1 are used, the split line and chipping can be distinguished even in the case in which odd number of the prisms 23b1 are used, the surface on which the split line is formed and the angle of the split line can be detected by the same steps as the case in which even number of the prisms 23b1 are used.

Furthermore, in the above description, although the split line is linearly formed in one line on one surface of the tablet T, it is not limited thereto, and types of the split line are various, and for example, a plurality of the split line may be formed and a plurality of the split line may be formed radially from the center of the tablet T. For example, the split lines extending from the center of the tablet T is formed on one surface of the tablet T every 90 degrees or 120 degrees in the circumferential direction. When the split lines extending from the center of the tablet T is formed every 90 degrees in the circumferential direction, the entire split line has a cross-shape. Note that, as the tablet T, the tablet which does not have a ring-shape in a plane view may be used, and for example, a tablet which having an ellipse shape in a plan view may be used.

Depending on the type of the split line, two corresponding black triangles B1 may not appear on the position on the tablet T facing across the center of the tablet T. Even in this case, since two black triangles B1 appear on the corresponding position on the tablet T, two black triangles B1 have positional relationship related to the correspondence therebetween. Therefore, if the position of one of the black triangles B1 is found, the position of other black triangle B1 is found according to the position of said one black triangles B1. For example, if it is known that two black triangles B1 corresponding to the split line appear at the positions that form 120 degrees relative to the center of the tablet T that is the center (the positions in which the internal angle formed by two straight lines each linking the center of the tablet T and the centers of the two black triangles B1 is 120 degrees), when one of the black triangles B1 is detected, the other black triangles B1 should appear at the predetermined position where the angle formed between said predetermined position and the position of said one of the black triangles B1 is 120 degrees. If the other black triangle B1 appear on the predetermined position, that is, if two black triangles B1 are in the positional relationship in which the angle formed between two black triangles at the center of the tablet T is 120 degrees, it is determined that two black triangles B1 are formed by the split line. On the other hand, if the other black triangle B1 does not appear on the predetermined position, that is, if two black triangles B1 are in the positional relationship in which the angle formed between two black triangles at the center of the tablet T is not 120 degrees, it is determined that two black triangles B1 is not formed by the split line (formed by chipping or dirt).

Since the determination is performed based on the positional relationship, a positional relationship data indicating the positional relationship between two black triangles B1 corresponding to the split line is stored in the storage unit 54 beforehand. For example, in the above example, a data indicating that the positions are in the positional relationship in which the internal angle formed by two straight lines each linking the center of the tablet T and the centers of the two black triangles B1 is 120 degrees is stored. The image processing unit 51 determines that two black triangles B1 are formed by the split line when two black triangles B1 (the portions where the shading is darker than the predetermined darkness) in the image are present at the corresponding positions on the tablet T based on the positional relationship data stored by the storage unit 54. For example, when one black triangle B1 appears at the position of −60 degrees and the other black triangle appears at the position of −180 degrees which is the corresponding position based on the positional relationship data, it is determined that two black triangles B1 are formed by the split line. On the other hand, when two black triangles B1 in the image are not present at the corresponding positions on the tablet T or when a black triangle B1 other than the black triangles B1 based on the positional relationship data appears at a position which is not based on the positional relationship data, it is determined that the black triangles B1 are not formed by the split line. Note that the number of the black triangles B1 which appears in accordance with the split line is not limited to two, and the number of the black triangles B1 may be three or four. Even when the number of the black triangles B1 are two or more, the determination based on the aforementioned positional relationship can be performed as long as the positional relationship of the black triangles B1 are acquired.

In addition, in the above description, although the plurality of the prisms 23b1 are used as the light guide member 23b, it is not limited thereto, and for example, mirror and optical fiber may be used.

In addition, in the above description, although all side surfaces of the tablet T are imaged by providing the light guide member 23b, it is not limited thereto, and for example, the light guide member may not be provide and all side surfaces of the tablet T may be imaged by a plurality of cameras.

In addition, in the above description, although the upper surface of the tablet T is imaged together with the side surfaces of the tablet T, it is not limited thereto, and the upper surface of the tablet T may not be imaged because the split line formed on one of the upper surface and the bottom surface of the tablet T can be detected by only imaging all side surfaces (all around the outer circumferential surface) of the tablet T.

In addition, in the above description, although all side surfaces (all around the side surface) are imaged, it is not limited thereto, and for example, the split line formed on one surface of the tablet T may be detected by imaging more than half around the side surface of the tablet T. In this case, since it would be difficult to distinguish the split line, and chipping or dirt as described above, the tablet with chipping or dirt may be omitted beforehand when inputting the tablet T in the supplying device 10. Otherwise, the black triangles by chipping or dirt and the black triangles by the split line may be distinguished by the first threshold and the second threshold illustrated in FIGS. 12 and 14. By this, more than half around of the side surface of the tablet T may be imaged, however, to improve the detection accuracy, it is preferable to image all around the side surface of the tablet T.

In addition, in the above description, although both the surface of the tablet T on which the split line is formed and the angle of the split line is specified by the image processing unit 51, it is not limited thereto, and for example, only the angle of the split line may by specified by the image processing unit 51.

In addition, in the above description, although a tablet which is circular in a plan view and in which the upper and bottom surfaces are plane or curved may be used as the tablet T that is the printing target, for example, tablets in a spindle-shape, a perfect circle, a disc-shape, a lens-shape, a triangle-shape, and an ellipse-shape may be used.

In addition, in the above description, although the tablet T is carried in two lines, it is not limited thereto, and the lines may be one or three or four or more, and the number of the carrying paths and the number of the carrying belts 21a and 31a are not limited. Furthermore, the shape of the suction holes 21g of the carrying belts 21a and 31a is not specifically limited.

In addition, in the above description, although the printing head 24a is provided for each carrying path of the tablet T, it is not limited thereto, and for example, one printing head 24a may perform printing on the tablet T on two or more lines.

In addition, in the above description, although the printing head in which the nozzles 24b are aligned in a line is provided as the inkjet-scheme printing head 24a, it is not limited thereto, and for example, a printing head in which the nozzle 24b are aligned in a plurality of lines may be used. Furthermore, a plurality of the printing head 24a aligned along the carrying direction A1 may be used.

In addition, in the above description, although the drying devices 26, 26, and 42c are provided, the number of the drying devices are not limited. For example, the drying device 26 may not be provided and the drying devices 36 and 42c may be provided, or the drying devices 26 and 36 may not be present and the drying device 42c may be provided, or the drying device 42c may not be provided and the drying devices 26 and 36 may be provided. Furthermore, all three drying devices 26, 36, and 42c may not be provided because ink and the tablet T may not require drying depending on their kinds.

In addition, in the above description, although the first printing device 20 and the second printing device 30 are vertically arranged and both or one of the upper and the bottom surfaces of the tablet T are printed, it is not limited thereto, and for example, only the first printing device 20 may be provided to print only one surface of the tablet T.

Here, as the tablets, tablets for medical use, eating, washing, industrial use, or aromatic use may be included. Furthermore, as the tablets, uncoated tablets (plane tablets), sugar-coated tablets, film-coated tablets, enteric tablets, gelatin encapsulated tablets, multi-layer tablets, or dry-coated tablets are included, and various capsules such as hard capsules and soft capsules may be included in the tablets. In addition, as the shapes of the tablets, various shapes such as disc-shape, lens-shape, triangle-shape, and ellipse-shape may be applied. Moreover, if the tablets that are printing target are for medical use or for eating, edible ink is preferable for the ink to be used. As the edible ink, either of synthetic dye ink, natural dye ink, dye ink, and pigment ink may be used.

As above, although some embodiments of the present disclosure are described, those embodiments are only provided as examples, and are not intended to limit the scope of the invention. Those new embodiments can be implemented in other various forms, and various omissions, replacements, and changed can be made without departing from the abstract of the invention. These embodiments and variations thereof are included in the scope and abstract of the invention, and are included in the invention described in the claims and equivalent ranges thereto.

### REFERENCE SIGN

1: tablet printing apparatus
21: carrying device (carrying unit)
23: first imaging device (imaging unit)
24: printing head device (printing unit)
31: carrying device (carrying unit)
33: first imaging device (imaging unit)
34: printing head device (printing unit)
50: controlling device (controlling unit)
T: tablet

1. A tablet printing apparatus comprising:
an imaging device configured to image a side surface of a tablet on which a split line is formed on one surface;
a conveyor configured to carry the tablet;
a printing head configured to print information on the tablet carried by the conveyor; and
a controller
wherein the controller operable to:
a. specifies an angle of the split line based on an image of the side surface of the tablet obtained by the imaging device,
b. creates a printing data for printing the information in accordance with the angle of the split line using the specified angle of the split line, and
c. controls the printing head to perform printing on the tablet using the printing data.

2. The tablet printing apparatus according to claim 1, wherein the imaging device images more than half around or all around the side surface of the tablet.

3. The tablet printing apparatus according to claim 1, wherein the controller comprises:
an image processing unit configured to specify an angle of the split line based on the image of the side surface of the tablet obtained by the imaging device;
a printing processing unit configured to create the printing data for printing an information aligned with the split line based on the angle of the split line specified by the image processing unit; and
a storage unit configured to store the printing data, and
the controller controls the printing head to print on the tablet using the printing data stored in the storage unit.

4. The tablet printing apparatus according to claim 1, wherein the controller comprises:
an image processing unit configured to specify a surface on which the split line is formed based on the image obtained by the imaging device; and
a printing processing unit configured to create the printing data based on the information related to the surface on which the split line is formed and the angle of the split line.

5. The tablet printing apparatus according to claim 1, wherein when a plurality of portions where shadings are darker than a predetermined darkness is present in the image in accordance with corresponding positions on the tablet, the controller determines that the plurality of portions is formed by the split line.

6. The tablet printing apparatus according to claim 1, wherein when two portions where shadings are darker than a predetermined darkness is present at positions facing across a center of the tablet in the image, the controller determines that the two portions are formed by the split line.

7. The tablet printing apparatus according to claim 1, wherein the controller determines if there are chippings on one or both surface of the tablet or not based on the image.

8. The tablet printing apparatus according to claim 1, wherein the imaging device images an upper surface of the tablet together with the side surface of the tablet.

9. The tablet printing apparatus according to claim 1, wherein:
the imaging unit has an imaging unit and a plurality of light guide members,
the imaging unit is provided at a position facing the tablet T carried by the conveyor, and
the plurality of the light guide members is arranged in a ring-shape relative to a center position of an imaging region of the imaging unit.

10. The tablet printing apparatus according to claim 9, wherein each two of the plurality of the light guide members is arranged in a ring shape in a horizontal plane so as to face each other in parallel.

11. A tablet printing method comprising:
an imaging process of imaging a side surface of a tablet on which a split line is formed on one surface;
a creation process of specifying an angle of the split line based on an image of the side surface of the tablet obtained in the imaging process, and creating a printing data for printing the information in accordance with the angle of the split line using the specified angle of the split line; and
a printing process of printing the information on the carried tablet in accordance with the split line using the created printing data.

12. The tablet printing method according to claim 11, wherein in the imaging process, more than half around or all around the side surface of the tablet are imaged.

13. The tablet printing method according to claim 11, wherein in the creation process, a surface on which the split line is formed is specified, and the printing data is created based on the information related to the surface on which the split line is formed and the angle of the split line.

14. The tablet printing method according to claim 11, wherein in the creation process, when a plurality of portions where shadings are darker than a predetermined darkness is present in the image in accordance with corresponding positions on the tablet, it is determined that the plurality of the darker portions is formed by the split line.

15. The tablet printing method according to claim 11, wherein in the creation process, when two portions where shadings are darker than a predetermined darkness is present at positions facing across a center of the tablet in the image, it is determined that the two darker portions are formed by the split line.

16. The tablet printing method according to claim 11, wherein in the creation process, if there are chippings on one or both surface of the tablet or not is determined based on the image.

17. The tablet printing method according to claim 11, wherein in the imaging process, an upper surface of the tablet is imaged together with the side surface of the tablet.

18. The tablet printing method according to claim 11, wherein in the imaging process, the image of the side surface of the tablet is imaged via a light guide member.
